(19) United States
(12) Patent Application Publication
(10) Pub. No.: US 2012/0308902 A1
(43) Pub. Date: Dec. 6, 2012

(54) AIR ELECTRODE FOR AIR BATTERY AND AIR BATTERY COMPRISING THE SAME

(75) Inventors: Fuminori Mizuno, Susono-shi (JP); Hidetaka Nishikori, Susono-shi (JP); Shougo Higashi, Nisshin-shi (JP)

(73) Assignee: TOYOTA JIDOSHA KABUSHIKI KAISHA, Toyota-shi, Aichi (JP)

(21) Appl. No.: 13/515,081

(22) PCT Filed: Dec. 18, 2009
(86) PCT No.: PCT/JP2009/071176

§ 371 Date: Aug. 20, 2012

(51) Int. Cl. H01M 8/22; B82Y 30/00

(52) U.S. Cl. 429/405; 977/734

(57) ABSTRACT

An air electrode for an air battery with high rate characteristics, and an air battery comprising the air electrode. Disclosed is an air electrode for an air battery, including at least an air electrode layer, wherein the air electrode layer includes a carbon material in which graphene layers are unidirectionally oriented, and a Basal plane of the carbon material is exposed on a surface of the carbon material.

### TECHNICAL FIELD

The present invention relates to an air electrode for an air battery with high rate characteristics, and an air battery comprising the air electrode.

### BACKGROUND ART

A lithium air battery is a rechargeable battery comprising a metallic lithium or lithium compound as a negative electrode active material and oxygen as a positive electrode active material. Since the positive electrode active material, oxygen, can be obtained from the air, it is not needed to encapsulate a positive electrode active material in the battery. In theory, therefore, the lithium air battery can realize a larger capacity than secondary batteries comprising a solid positive electrode active material.

In a lithium air battery, the reaction described by the following formula (1) proceeds at a negative electrode upon discharging the battery:

21Li→2Li⁺+2e⁻ (1)

Electrons generated by the reaction described by the formula (1) pass through an external circuit, work by an external load, and then reach a positive electrode. Lithium ions (Li⁺) generated by the reaction described by the formula (1) are transferred by electro-osmosis from the negative electrode side to the positive electrode side through an electrolyte sandwiched between the negative electrode and the positive electrode.

Also, upon discharging the battery, the reactions described by the following formulae (2) and (3) proceed at the positive electrode:

2Li⁺+O₂+2e⁻→Li₂O₂ (2)

2Li⁺→1/2O₂+2e⁻→Li₂O (3)

Lithium peroxide (Li₂O₂) and lithium oxide (Li₂O) thus produced are stored at the air electrode as solid products.

Upon charging the battery, a reaction which is reverse to the one described by the above formula (1) proceeds at the negative electrode, and reactions which are reverse to the ones described by the above formulae (2) and (3) proceed at the positive electrode, thereby regenerating metallic lithium at the negative electrode. Because of this, discharging becomes possible again.

In recent years, in lithium air batteries, applications of a power source for electric vehicles have been expected and larger capacity to realize a long-term driving has been demanded.

As a lithium air battery technique for increasing capacity, a non-aqueous electrolyte battery technique is disclosed in Patent Literature 1, which comprises a positive electrode, a negative electrode comprising a negative electrode active material capable of releasing metal ions, a non-aqueous electrolyte interposed between the positive and negative electrodes, and a battery case housing the positive electrode, the negative electrode and the non-aqueous electrolyte and being provided with an air hole for supplying oxygen to the positive electrode, the positive electrode comprising a carbonaceous material having an average distance d₀₀₂ between carbon planes of 0.37 nm or more and 0.42 nm or less, which is measured by powder X-ray diffraction, and a specific surface area of 600 m²/g or more, which is measured by a BET method.

### CITATION LIST

### Patent Literature

Patent Literature 1: Japanese patent No. 3735518

### SUMMARY OF INVENTION

### Technical Problem

In “Examples” of Patent Literature 1, the discharging capacity of the non-aqueous electrolyte secondary batteries of Examples using the carbonaceous material having the predetermined average distance d₀₀₂ and specific surface area was compared with that of the non-aqueous electrolyte secondary batteries of Comparative Examples using the carbonaceous material not having at least one of the average distance and specific surface area. However, in “Examples”, studies have not been carried out into rate characteristics, that is, characteristics that the battery discharging capacity obtained by consuming O₂ in the batteries disclosed in “Examples” is changed by the amount of O₂ consumed per unit time, which is the rate of reduction of O₂. Therefore, it is not apparent whether or not the non-aqueous electrolyte batteries disclosed in Patent Literature 1 have practicable rate characteristics.

The present invention was achieved in view of the above circumstance. An object of the present invention is to provide an air electrode for an air battery with high rate characteristics and an air battery comprising the air electrode.

### Solution to Problem

The air electrode for the air battery of the present invention comprises at least an air electrode layer,

wherein the air electrode layer comprises a carbon material in which graphene layers are unidirectionally oriented, and a Basal plane of the carbon material is exposed on a surface of the carbon material.

In the air electrode for the air battery of such a structure, the air electrode layer comprises the carbon material in which graphene layers are unidirectionally oriented. Therefore, it is possible to improve oxygen reduction ability on the carbon material and realize high rate characteristics when the air electrode for the air battery is incorporated into the air battery.

In the air electrode for the air battery of the present invention, it is preferable that the carbon material has an interplanar spacing between (002) planes of 3.4 Å or less and a D/G ratio of 0.2 or less.

Because the air electrode for the air battery of such a structure comprises the carbon material having an appropriate interplanar spacing and DIG ratio, it is possible to exhibit high electron donating and receiving ability between carbon and oxygen.

In the air electrode for the air battery of the present invention, it is preferable that the carbon material is vapor-grown carbon fibers, or carbon microspheres heated at a temperature of 2,000° C. or more.

The air battery of the present invention comprises at least an air electrode, a negative electrode and a liquid electrolyte present between the air and negative electrodes,

wherein the air electrode is the air electrode for the air battery.

Because the air battery of such a structure comprises the air electrode for the air battery, it is possible to realize high rate characteristics.

### Advantageous Effects of Invention

According to the present invention, the air electrode layer comprises the carbon material in which graphene layers are unidirectionally oriented, therefore, it is possible to improve oxygen reduction ability on the carbon material and realize high rate characteristics when the air electrode for the air battery is incorporated into the air battery.

### BRIEF DESCRIPTION OF DRAWINGS

FIG. 1 is a view showing an example of the layer structure of the metal-air battery used in the present invention and is also a schematic view of a section of the battery cut along the layer stacking direction.

FIG. 2 is a schematic sectional view of an end section of the carbon material used in the present invention.

FIG. 3 is a graph showing a relationship between electrochemical effective surface area and oxygen reduction rate of the carbon materials in Examples 1 and 2, and Comparative Examples 1 to 4.

### DESCRIPTION OF EMBODIMENTS

### 1. Air Electrode for Air Battery

The air electrode for the air battery of the present invention comprises at least an air electrode layer,

wherein the air electrode layer comprises a carbon material in which graphene layers are unidirectionally oriented, and a Basal plane of the carbon material is exposed on a surface of the carbon material.

In the present invention, “Basal plane of a carbon material” refers to “strong plane having hexagonal lattice formed by a covalent bond between carbon atoms, which is produced by three sp² orbitals each having a bond angle of 120° in a graphite crystal”.

It has been known that the conventional air electrode comprising a carbon material such as ketjen black (hereinafter referred to as KB) can realize large discharged capacity by being incorporated into an air battery. However, as shown in the below-described “Examples”, the carbon material used for such a conventional air electrode has a low oxygen reduction rate per electrochemical effective surface area similarly as in other carbon materials such as an activated carbon.

Because the carbon material used for the conventional air electrode for the air battery, such as KB, has a high specific surface area and a low graphitization degree, a Basal plane and an Edge plane are randomly present. The Edge plane of the carbon material refers to a part other than the Basal plane of the carbon material, such as a terminal part of the hexagonal lattice or a structural defect in the graphene layer. The ratio of the Basal plane and Edge plane varies depending on the type of carbon material.

Although oxygen adsorption performance of the conventionally-used carbon material, in which both the Basal plane and the Edge plane are present, varies depending on the type of carbon material, oxygen reduction rate is not varied. This is considered because the oxygen reduction rate of the carbon corresponds to electron donating and receiving ability between carbon and oxygen, and electron donating and receiving ability between carbon and oxygen in the state that both the Basal plane and the Edge plane are present does not widely vary depending on the type of carbon.

Therefore, the reason why low rate characteristics cannot be improved in the case that the conventionally-used carbon material is incorporated into the air battery is considered as follow. The electron donating and receiving ability between carbon and oxygen is low in the conventionally-used carbon material having a skeleton structure in which both the Basal plane and the Edge plane are present.

Because the air electrode for the air battery of the present invention comprises the carbon material in which graphene layers are unidirectionally oriented in the air electrode layer, and the Basal plane of the carbon material is exposed on the surface of the carbon material, it is possible to significantly improve an oxygen reduction rate per electrochemical effective surface area and to increase rate characteristics of the battery.

In the present invention, as an example of the structure in which “Basal plane of a carbon material is exposed on a surface of the carbon material”, there may be mentioned the structure which can be confirmed by a TEM observation, in which the end section of the carbon material is closed and the Basal plane is a terminal end.

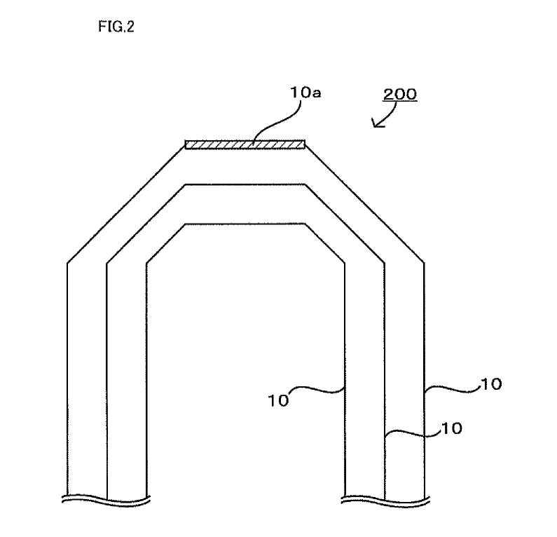

FIG. 2 is a schematic sectional view of the end section of the carbon material used in the present invention. FIG. 2 shows the end section of the carbon material in which graphene layers 10 are triply-stacked. The double wavy line shown in the figure indicates the omission of a part of the figure.

The carbon material shown in the figure has the structure in which end section 200 is closed and Basal plane 10a is a terminal end. The carbon material having such a structure confirmed by a TEM observation can be used in the present invention.

In the carbon material used in the present invention, it is preferable that the carbon material has an interplanar spacing between (002) planes of 3.4 Å or less and a D/G ratio of 0.2 or less.

If the carbon material has an interplanar spacing between (002) planes of more than 3.4 Å or a D/G ratio of more than 0.2, crystallinity of the carbon material is too low, so that electron donating and receiving ability between carbon and oxygen is low.

It is more preferable that the carbon material has an interplanar spacing between (002) planes of 3.36 Å or less. It is further more preferable that the carbon material has an interplanar spacing between (002) planes of 3.354 Å or more.

Since the carbon material is more likely to show a Basal orientation as the D/G ratio of the carbon material is closer to 0, the closer to 0 the D/G ratio is, the more preferable it is.

In the present invention, “interplanar spacing between (002) planes of a carbon material” means an average interplanar spacing between (002) surfaces of the carbon material, which is measured by an X-ray diffraction method or a powder X-ray diffraction method. In the present invention, “D/G ratio” means a ratio of the peak intensity of D band at 1360 cm⁻¹ to the peak intensity of G band at 1580 cm⁻¹ in the raman spectrum of the carbon material.

As a specific example of the carbon material used in the present invention, preferred is vapor-grown carbon fibers, or carbon microspheres heated at a temperature of 2,000° C. or more. As shown in the below-described Examples, the carbon material meets the condition that the interplanar spacing between (002) planes is 3.4 Å or less and the D/G ratio is 0.2 or less, so that electron donating and receiving ability between carbon and oxygen is significantly high.

Examples of other carbon materials used in the present invention include natural graphite, etc.

The content of the carbon material in the air electrode layer of the present invention is preferably, for example, in the range of 10% by mass to 99% by mass, more preferably in the range of 20% by mass to 95% by mass. If the content of the carbon material is too small, the number of reaction sites may be decreased and may result in a decrease in battery capacity. If the content of the carbon material is too large, the content of the catalyst described below is smaller and may result in poor catalyst performance.

The air electrode of the present invention comprises the above-described air electrode layer of the present invention. In addition to this, the air electrode generally comprises an air electrode current collector and an air electrode lead connected to the air electrode current collector.

In addition to the above-described carbon material, the air electrode layer in the air battery of the present invention may further comprise at least one of a catalyst and a binder, as needed.

As the catalyst used for the air electrode layer, for example, there may be mentioned inorganic ceramics such as manganese dioxide and cerium dioxide, organic complexes such as cobalt phthalocyanine, and composite materials thereof. The content of the catalyst in the air electrode layer is preferably, for example, in the range of 1% by mass to 90% by mass. If the catalyst content is too small, the catalyst may not provide sufficient catalyst performance. If the catalyst content is too large, the content of the electroconductive material is relatively smaller and may result in a decrease in the number of reaction sites and may result in a decrease in battery capacity.

From the point of view that an electrode reaction is performed more quickly, the above-described electroconductive material preferably supports the catalyst.

The air electrode layer is only needed to comprise at least the electroconductive material. Preferably, the air electrode layer further comprises a binder for fixing the electroconductive material. Examples of the binder include polyvinylidene fluoride (PVdF) and polytetrafluoroethylene (PTFE). The content of the binder in the air electrode layer is not particularly limited; however, it is preferably, for example, 40% by mass or less, more preferably in the range of 1% by mass to 10% by mass.

In the case of using a solvent for preparing air electrode layer materials such as the catalyst and binder, it is preferable to use a solvent having a boiling point of 200° C. or less, and it is more preferable to use acetone, DMF and NMP.

The thickness of the air electrode layer varies depending on the intended use of the air battery; however, it is preferably, for example, in the range of 2 μm to 500 μm, more preferably in the range of 5 μm to 300 μm.

### (Air Electrode Current Collector)

The air electrode current collector used in the present invention collects current from the air electrode layer. The air electrode current collector is not particularly limited as long as it has electrical conductivity. Examples of the air electrode current collector include porous support formed of metal or carbon, fibra, non-woven fabric and foamed material. Examples of the metal include stainless steel, nickel, aluminum, iron and titanium. Examples of the form of the air electrode current collector include a foil form, a plate form and a mesh (grid) form. Among them, the air electrode current collector is preferably a carbon paper or a metal mesh in the present invention from the viewpoint of excellent current collection efficiency. In the case of using the air electrode current collector in a mesh form, generally, the air electrode current collector in the mesh form is provided inside the air electrode layer. Moreover, the air battery of the present invention may have a different air electrode current collector (such as a current collector in a foil form) which collects charge collected by the air electrode current collector in a mesh form.

The thickness of the air electrode current collector is preferably, for example, in the range of 10 μm to 1,000 μm, more preferably in the range of 20 μm to 400 μm.

### 2. Air Battery

The air battery of the present invention comprises at least an air electrode, a negative electrode and a liquid electrolyte present between the air and negative electrodes, wherein the air electrode is the air electrode for the air battery.

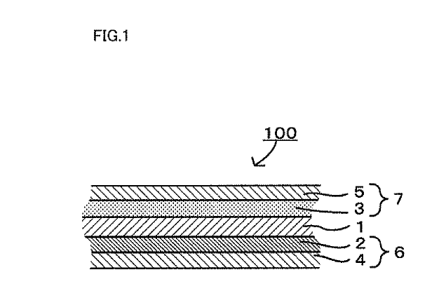

FIG. 1 is a view showing an example of the layer structure of the metal-air battery used in the present invention and is also a schematic view of a section of the battery cut along the layer stacking direction. The metal-air battery used in the present invention is not limited to this example only.

Metal-air battery 100 comprises air electrode 6, negative electrode 7 and liquid electrolyte layer 1. Air electrode 6 comprises air electrode layer 2 and air electrode current collector 4. Negative electrode 7 comprises negative electrode active material layer 3 and negative electrode current collector 5. Liquid electrolyte layer 1 is sandwiched between air electrode 6 and negative electrode 7. As air electrode 6, the above-described air electrode for the air battery of the present invention is used.

Among the components of the air battery of the present invention, the air electrode is as described above. Hereinafter, the components of the air battery of the present invention other than the air electrode, such as negative electrode and liquid electrolyte present between the air and negative electrodes, will be described in order.

### (Negative Electrode)

The negative electrode in the air battery of the present invention preferably comprises a negative electrode layer which comprises a negative electrode active material. In addition to this, the negative electrode generally comprises a negative electrode current collector and a negative electrode lead connected to the negative electrode current collector.

### (Negative Electrode Layer)

The negative electrode layer in the air battery of the present invention comprises a negative electrode active material comprising a metal and an alloy material. Examples of the metal and alloy material for the negative electrode active material include alkali metals such as lithium, sodium and potassium; elements in group 2 such as magnesium and calcium; elements in group 13 such as aluminium; transition metals such as zinc and iron; and the alloy material or compound containing the above-described metals.

Examples of an alloy having a lithium element include a lithium aluminum alloy, a lithium tin alloy, a lithium lead alloy and a lithium silicon alloy. Examples of the metallic oxide having a lithium element include a lithium titanium oxide. Examples of the metallic nitride having a lithium element include a lithium cobalt nitride, a lithium iron nitride and a lithium manganese nitride. For the negative electrode layer, lithium covered with a solid electrolyte can be used.

The negative electrode layer may be one comprising a negative electrode active material only or one comprising a negative electrode active material and at least one of a carbon material and a binder. For example, when the negative electrode active material is in a foil form, the negative electrode layer can be one comprising the negative electrode active material only. When the negative electrode active material is in a powder form, the negative electrode layer can be one comprising the negative electrode active material and a binder. Since the carbon material and binder are the same as those described above under “Air electrode”, explanation of them is omitted here.

### (Negative Electrode Current Collector)

The material of the negative electrode current collector in the air battery of the present invention is not particularly limited as long as it has electrical conductivity. Examples of the material include copper, stainless steel, nickel and carbon. Examples of the form of the negative electrode current collector include a foil form, a plate form and a mesh (grid) form. In the present invention, the below-described battery case may also function as a negative electrode current collector.

### (Liquid Electrolyte)

The liquid electrolyte in the air battery of the present invention is a layer that is formed between the air electrode layer and the negative electrode layer, and is responsible for conduction of metal ions.

As the liquid electrolyte, an aqueous liquid electrolyte or a non-aqueous liquid electrolyte can be used.

It is preferable to select the type of non-aqueous liquid electrolyte appropriately, depending on the type of metal ions to be conducted. For example, the non-aqueous liquid electrolyte in lithium air batteries generally contains a lithium salt and a non-aqueous solvent. Examples of the lithium salt include inorganic lithium salts such as LiPF₆, LiBF₄, LiClO₄ and LiAsF₆, and organic lithium salts such as LiCF₃SO₃, LiN(SO₂CF₃)₂(Li-TFSI), LiN(SO₂C₂F₅)₂ and LiC(SO₂CF₃)₃. Examples of the non-aqueous solvent include ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolactone, sulfolane, acetonitrile, 1,2-dimethoxymethane, 1,3-dimethoxypropane, diethyl ether, tetrahydrofuran, 2-methyltetrahydrofuran and mixtures thereof. From the point of view that dissolved oxygen can be efficiently used for reaction, the non-aqueous solvent is preferably a solvent with high oxygen solubility. The concentration of the lithium salt in the non-aqueous liquid electrolyte is, for example, in the range of 0.5 mol/L to 3 mol/L, for example. In the present invention, as the non-aqueous liquid electrolyte, a low-volatile liquid such as an ionic liquid may be used, which is typified by ammonium salts such as tetraethylammonium bis(trifluoromethanesulphonyl)imide.

A non-aqueous gel electrolyte used in the present invention is generally obtained by adding a polymer to a non-aqueous liquid electrolyte for gelation. For example, the non-aqueous gel electrolyte of the lithium air battery is obtained by adding a polymer such as polyethylene oxide (PEO), polyacrylonitrile (PAN) or polymethylmethacrylate (PMMA) to the non-aqueous liquid electrolyte for gelation. In the present invention, an LiTFSI(LiN(CF₃SO₂)₂)-PEO-based non-aqueous gel electrolyte is preferred.

As the aqueous liquid electrolyte used for the air battery, especially for the lithium air battery, a mixture of water and a lithium salt is generally used. Examples of the lithium salt include LiOH, LiCI, LiNO₃ and CH₃CO₂Li.

The aqueous liquid electrolyte and non-aqueous liquid electrolyte can be used by mixing with a solid electrolyte. As the solid electrolyte, an Li—La—Ti—O-based solid electrolyte, etc. can be used.

### (Separator)

When the battery of the present invention has a structure of stacked laminates, each comprising an air electrode, liquid electrolyte and negative electrode stacked in this order, from the viewpoint of safety, a separator is preferably provided between the air electrode of a laminate and the negative electrode of a different laminate. Examples of the separator include a porous membrane of polyethylene, polypropylene or the like and a nonwoven fabric such as resin nonwoven fabric or glass fiber nonwoven fabric.

### (Battery Case)

The air battery of the present invention generally comprises a battery case for housing the air electrode, negative electrode, liquid electrolyte and so on. The battery case may be in a coin form, a plate form, a cylinder form, a laminate form, etc. The battery case may be an open battery case or closed battery case. The open battery case is a battery case having a structure in which at least the air electrode layer can be in full contact with the air. On the other hand, when the battery case is a closed battery case, the closed battery case is preferably provided with a gas (air) introduction tube and a gas (air) exhaust tube. In this case, the introduced and exhaust gas preferably has a high oxygen concentration and is more preferably pure oxygen. Upon discharging, it is preferable to increase the oxygen concentration. Upon charging, it is preferable to decrease the oxygen concentration.

### EXAMPLES

### 1. Preparation of Carbon Materials

As materials used in an air electrode layer, carbon materials of the following Examples 1 and 2, and Comparative Examples 1 to 4 were prepared.

### Example 1

As a carbon material, vapor-grown carbon fibers (hereinafter referred as to VGCF) (manufactured by: Showa Denko K.K.) were prepared.

### Example 2

As a carbon material, a burned product of carbon microspheres burned at 2,600° C. (manufactured by: Tokai Caron Co., Ltd.) was used.

### Comparative Example 1

As a carbon material, ketjen black (KB; product name: ECP600JD; manufactured by: Ketjen Black International Co., Ltd.) was used.

### Comparative Example 2

As a carbon material, a burned product of carbon microspheres burned at 1,100° C. (manufactured by: Tokai Carbon Co., Ltd.) was used.

### Comparative Example 3

As a carbon material, activated carbon (manufactured by: KUREHA CORPORATION) was used.

### Comparative Example 4

As a carbon material, Super P (manufactured by: TIMCAL Graphite & Carbon) was used.

### 2. XRD Measurement

A XRD pattern of each of the carbon materials of Examples 1 and 2, and Comparative Examples 1 to 4 was measured by a powder X-ray Diffraction method to calculate an interplanar spacing between (002) planes. Specific measurement condition and analysis method are as follows:

Radiation source: CuKα

Tube voltage: 40 kV

Tube current: 40 mA

Analysis method: FT method

### 3. Raman Measurement

Raman measurement was performed on the carbon materials of Example 1 and 2, and Comparative Examples 1 to 4 using a laser light source with a wavelength of 488 nm by means of a laser Raman spectrophotometer. In the obtained raman spectrum of each of the carbon materials, the peak intensity at 1360 cm⁻¹ (D band) and the peak intensity at 1580 cm⁻¹ (G band), which were obtained by subtracting the base line, were calculated to determine the peak intensity at D band to the peak intensity at G band.

Measurement was performed at any three points per carbon material to calculate the peak intensity ratio each at the measured three points. The average of the peak intensity ratio each at the measured three points was referred to as a D/G ratio of the carbon material.

The following Table 1 lists the values of the interplanar spacing between (002) planes obtained in the XRD measurement and the D/G ratio obtained in the raman measurement. As is clear from Table 1, each of the carbon materials of Examples 1 and 2 had an interplanar spacing between (002) planes of 3.4 Å or less. However, each of the carbon materials of Comparative Examples 1 to 4 had an interplanar spacing between (002) planes of more than 3.5 Å. On the other hand, each of the carbon materials of Examples 1 and 2 had a D/G ratio of 0.2 or less. However, each of the carbon materials of Comparative Examples 1 to 4 had an interplanar spacing between (002) planes of more than 0.8.

TABLE 1

| | Interplanar spacing (Å) | |
|---|---|---|
| | between (002) planes | D/G ratio |
| Example 1 | 3.365 | 0.065 |
| Example 2 | 3.375 | 0.168 |
| Comparative example 1 | 3.77 | 1.128 |
| Comparative example 2 | 3.570 | 0.823 |
| Comparative example 3 | 3.700 | 0.966 |
| Comparative example 4 | 3.525 | 0.887 |

### 4. Production of Triode Cell

A triode cell comprising an air electrode layer using each of the carbon materials of Examples 1 and 2, and Comparative Examples 1 to 4 was produced.

First, each of the carbon materials and Teflon (trademark) binder were mixed in a mass ratio of 9:1, and the mixture was rolled so that the thickness thereof was 300 μm. Then, the thus-rolled product was attached to a nickel current collector used as an air electrode current collector, followed by vacuum drying at 120° C. Thereby, an air electrode was produced.

The obtained air electrode was impregnated with acetonitrile solution (salt concentration: 0.1 M) under vacuum, in which tetraethylammonium bis(trifluoromethanesulphonyl)imide (hereinafter referred to as TEATFSI) being a kind of a tetraethylammonium salt was dissolved. Thereby, a working electrode was obtained. In addition to the working electrode, a reference electrode (Ag/Ag⁺), a counter electrode (Ni) and a liquid electrolyte of acetonitrile solution (salt concentration: 0.1 M) in which TEATFSI was dissolved were prepared to produce a triode cell.

Furthermore, oxygen was bubbled in the liquid electrolyte in the triode cell for 30 minutes at flow rate of 50 mL/minute to make the liquid electrolyte be into an oxygen saturated state.

### 5. Calculation of Electrochemical Effective Surface Area

Unlike the total specific surface area of the carbon material, which is determined by N₂ adsorption or the like, an electrochemical effective surface area refers to a surface area of a carbon surface with electrochemical activity which can form an electrical double layer on the carbon surface. Measurement and calculation methods are as follows.

In the triode cell comprising an air electrode layer using each of the carbon materials of Examples 1 and 2, and Comparative Examples 1 to 4, electrode potential was swept in the range from −1.7 V to 0.3 V (Ag/Ag+) at a scanning rate of 100 mV/second by cyclic voltammetry, thereby obtaining a voltammogram. In the obtained voltammogram, difference between oxidation and reduction currents at −0.25 V was standardized in mass per unit area to calculate capacity of the electrical double layer. The thus-calculated value was referred to as an electrochemical effective surface area.

### 6. Calculation of Oxygen Reduction Rate

The oxygen reduction rate is a rate upon oxygen reduction. Measurement and calculation methods are as follows.

In the triode cell comprising an air electrode layer using each of the carbon materials of Examples 1 and 2, and Comparative Examples 1 to 4, electrode potential was swept in the range from natural potential to −1.7 V (Ag/Ag+) at a scanning rate of 2 mV/second by cyclic voltammetry, thereby obtaining a voltammogram. The value of the slope of the reduction current in the range from −1.15 V to −1.25 V, which was read from the obtained voltammogram, was divided by the electrochemical effective surface area. The thus-obtained value was referred to as a change in reduction current per effective surface area, that is, the oxygen reduction rate.

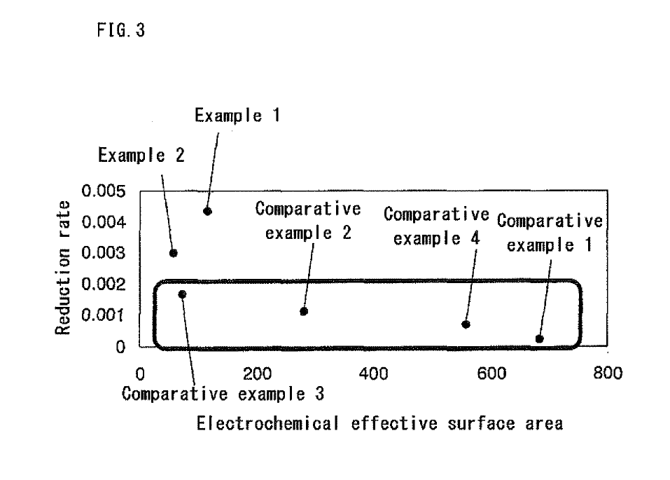

FIG. 3 is a graph showing a relationship between electrochemical effective surface area and oxygen reduction rate of the carbon materials in Examples 1 and 2, and Comparative Examples 1 to 4, and it is also a graph with the reduction rate on the vertical axis and the electrochemical effective surface area on the horizontal axis.

As shown in the range defined by heavy line in FIG. 3, each of the carbon materials of Comparative Examples 1 to 4 showed a low oxygen reduction rate (less than 0.002). On the other hand, each of the carbon materials of Examples 1 and 2 showed a high reduction rate (0.003 or more), so that it can be used for the air battery with high rate characteristics.

### 7. Summary

Each of the carbon materials of Comparative Examples 1 to 4, which was conventionally used for the air electrode for the air battery, had an interplanar spacing between (002) planes of more than 3.5 Å, and a D/G ratio of more than 0.8. From the result in which each of the carbon materials of Comparative Examples 1 to 4 had low oxygen reduction rate, it could be confirmed that electron donating and receiving ability between carbon and oxygen was low since the carbon materials conventionally used for the air battery had too large interplanar spacing between (002) planes and too high D/G ratio.

On the other hand, each of the carbon materials of Examples 1 and 2 had an interplanar spacing between (002) planes of 3.4 Å or less, and a D/G ratio of 0.2 or less. From the result in which each of the carbon materials of Examples 1 and 2 had high oxygen reduction rate, it could be confirmed that the electron donating and receiving ability between carbon and oxygen was high since the carbon materials used for the air electrode for the air battery of the present invention had an appropriate interplanar spacing between (002) planes and D/G ratio, therefore, high rate characteristics was able to be realized when the air electrode for the air battery of the present invention was incorporated into the air battery.

### REFERENCE SIGNS LIST

1: Liquid electrolyte layer
2: Air electrode layer
3: Negative electrode active material layer
4: Air electrode current collector
5: Negative electrode current collector
6: Air electrode
7: Negative electrode
10: Graphene layer
10a: Basal plane
100: Metal-air battery
200: End section of carbon material

1-4. (canceled)

5. An air electrode for an air battery, comprising at least an air electrode layer,
wherein the air electrode layer comprises a carbon material in which graphene layers are unidirectionally oriented, and a Basal plane of the carbon material is exposed on a surface of the carbon material, and
wherein the carbon material has an interplanar spacing between (002) planes of 3.4 Å or less and a DIG ratio of 0.2 or less.

6. The air electrode for the air battery according to claim 5, wherein the carbon material is vapor-grown carbon fibers, or carbon microspheres heated at a temperature of 2,000° C. or more.

7. An air battery comprising at least an air electrode, a negative electrode and a liquid electrolyte present between the air and negative electrodes,
wherein the air electrode is the air electrode for an air battery defined by claim 5.

8. The air battery according to claim 7, wherein the liquid electrolyte is a non-aqueous liquid electrolyte.
